(19) United States
(12) Patent Application Publication
(10) Pub. No.: US 2010/0022687 A1
(43) Pub. Date: Jan. 28, 2010

(54) METHOD FOR FORMING LIGNOCELLULOSIC PRODUCT

(75) Inventors: Wally Rowland, Eugene, OR (US); Tim C. Ayers, Eugene, OR (US); Robert J. Rubash, Eugene, OR (US); Scott Rowland, Pleasant Hill, OR (US); Philip N. Cote, Eugene, OR (US); Randall C. Zenke, Eugene, OR (US)

Correspondence Address: MARGER JOHNSON & MCCOLLOM, P.C., 210 SW MORRISON STREET, SUITE 400, PORTLAND, OR, 97204, US

(73) Assignee: WILLAMETTE VALLEY COMPANY, Eugene, OR (US)

(21) Appl. No.: 12/507,479

(22) Filed: Jul. 22, 2009

Related U.S. Application Data
(60) Provisional application No. 61/082,758, filed on Jul. 22, 2008.

(51) Int. Cl. C08L 97/02; B27N 3/00

(52) U.S. Cl. 524/35; 264/109

(57) ABSTRACT

A method for producing a lignocellulosic board product is provided. The method comprises providing lignocellulosic material. Furthermore, an adhesive binder system is provided comprising (a) an adhesive binder resin and (b) an extender and/or filler material comprising particularized bran material. The extender and/or filler material does not have an undesirable effect on the chemical and/or the physical properties of the adhesive binder resin to which the extender and/or filler material is added. It also does not impede the performance of the adhesive binder system during subsequent use in producing the lignocellulosic board product. Substantially no flour balling is present in the extender and/or filler material and in the adhesive binder system, respectively. Then, the lignocellulosic material and the adhesive binder system are combined. Finally, the combined lignocellulosic material and adhesive binder system are formed into the lignocellulosic board product.

### REFERENCED TO RELATED APPLICATION

This application claims the benefit of U.S. Provisional Patent Application No. 61/082,758 filed on Jul. 22, 2008 which is incorporated herein by reference.

### BACKGROUND

This technology relates to adhesive systems used in the manufacture of certain lignocellulosic products, and to the lignocellulosic products that are formed using these adhesive systems. In embodiments herein, this technology is directed to adhesive systems comprising aldehyde resins used in the manufacture of plywood products, and to the plywood products that are formed using these aldehyde resin adhesive systems.

Aldehyde resin adhesive systems are well known in the manufacture of various lignocellulosic products. In order to improve the cost of manufacturing these lignocellulosic products, certain materials known as extenders can be added to these adhesive systems. Extenders are typically substances that are added to an adhesive to reduce the amount of the primary binder required per unit area, and in turn increased the profitability of selling the resultant lignocellulosic product. Examples of extenders used in aldehyde resin adhesive systems are flours, typically ground vegetable flour or grain flour, such as for example, corn flour or wheat flour.

A problem that exists with respect to the use of extenders is that they can have an undesirable effect on the chemical and/or the physical properties of the aldehyde resin adhesive systems to which they are added. If they are not properly incorporated into the system, this can impede the performance of the modified aldehyde resin adhesive systems during subsequent use in product manufacture.

### SUMMARY

A method is provided for producing a lignocellulosic board product. The method comprises providing lignocellulosic material and an adhesive binder system. The adhesive binder system comprises (a) an adhesive binder resin and (b) an extender and/or filler material comprising particularized bran material. The extender and/or filler material does not have an undesirable effect on the chemical and/or the physical properties of the adhesive binder resin to which said extender and/or filler material is added. It also does not impede the performance of the adhesive binder system during subsequent use in producing said lignocellulosic board product. The lignocellulosic material and the adhesive binder system are combined. Then, the combined lignocellulosic material and adhesive binder system is formed into the lignocellulosic board product.

### DESCRIPTION

The lignocellulosic products produced herein can be manufactured by a method that comprises consolidating or joining together lignocellulosic materials by the application of pressure and heat using an adhesive binder material. The method using the present technology is suitable in the processing of lignocellulosic materials in general to form lignocellulosic products, and is particularly useful for forming lignocellulosic board products, and more particularly is useful in creating plywood products.

The lignocellulosic product is typically a lignocellulosic board or panel formed of lignocellulosic material bound together by an adhesive system. In one embodiment, the adhesive system is an aldehyde resin. In another embodiment, the lignocellulosic product is plywood. The term “plywood” as used herein describes a composite board product formed of layers of wood, generally known as veneers, which are held together by application of an adhesive system, and formed into a board or panel through the application of heat and pressure.

The adhesive system of the present technology generally comprises (a) a base adhesive resin and (b) an extender material. In one embodiment, the extenders can be designed so that they do not have an adverse effect on the binding action of the adhesive system. In another embodiment, the extenders can have a positive effect on the binding properties of the adhesive system.

Bran is the hard outer layer, and is an integral part, of whole grain. Whole grain also includes endosperm and germ portions. Bran is present in and may be milled from any cereal grain such as rice, wheat, corn, oats and millet. For example, a kernel of wheat, sometimes referred to as the wheat berry, is the seed from which the wheat grows. Each seed contains three distinct parts that are separated during the milling process to produce flour. Wheat kernels include the following components: (a) Endosperm which includes about 83% of the kernel weight and the source of white flour, (b) Bran which includes about 14.5% of the kernel weight and contains a share of the protein, and (c) Germ which includes about 2.5% of the kernel weight and is the sprouting section of the seed.

Historically, the plywood industry uses white flour, such as wheat flour, as an additive to adhesive mixes. However, the use of wheat flour causes “flour balling”, i.e., the formation of lumps of flour, in one embodiment flour balling, which adversely affects the adhesive system containing that extender. Flour balling, particularly wheat balling, is a common occurrence in the industry. The presence of flour balls causes the following problems with respect to the adhesive system:
Less than 100% utilization of flour extender
Plugging of filters
Viscosity variations
Performance variations
Adhesive stability

Whole bran husks have been used in the past but the products have been very inconsistent and full of oversized bran particles. This has limited the products use to roller coater applications, while the industry employs mostly spray line and curtain coater applications. These problems often result due to spray and filter clogging which undermines continuous operation It would also be desirable to uncover a procedure for adding bran to industrial-grade flour to reduce cost and for purposes of disposing of the material.

It has now been determined that using particularized bran material in the adhesive binder system has no substantial negative effects on the above-described spraying and filtering operations. Therefore, it has now been ascertained that the subject adhesive binder system, including particularized bran, is sprayable. Accordingly, the subject extenders and/or fillers employing particularized bran can now be used in applications that employ spray lines and curtain coaters. Thus, one can utilize this new blended extender containing particularized bran in all adhesive system application types, not just in roller coater systems.

It has now been discovered that a significant amount of bran material can be used in the extender material of the subject adhesive system while maintaining or enhancing the performance characteristics of the aldehyde resin adhesive systems to which they are added which are described herein. Thus the performance of these modified aldehyde resin adhesive systems during subsequent use in product manufacture will not be impeded and can even improve product performance.

Extenders to which particularized bran has been added, as previously provided, can maintain or improve prepress tack, viscosity, and rheology of the adhesive system. The use of particularized bran has no detrimental effect and may, for example, also assist in preventing over-penetration of the adhesive system into adjoining substrates of the lignocellulosic product.

It has now been found that the particularized bran material suppresses flour ball formation. Therefore, the problems described above which are due to the presence of flour balling can be substantially reduced, and in an embodiment herein can be substantially eliminated. Thus, when particularized bran material is employed in the extender and/or filler, substantially no flour balling will subsequently result even if materials such as white flour, which typically undergo flour balling, are present. Therefore, substantially no flour balling is present in the extender and/or filler material and in the adhesive binder system, respectively. It is clear that using the particularized bran material in the Extender Material contributes not only to the maintenance of viscosity but also to pre-press tack and are substantially flour ball free.

Bran material, preferably in finely ground, dried form, can be utilized in the adhesive system of the present technology, typically as a component of the extender material. The other component of this extender can be white flour such as wheat flour or corn flour. The white flour and bran can be blended to predetermined percentages. This can make the overall product composition more consistent. The extender in one embodiment includes from about 5% by weight of particularized bran material, in another embodiment from about 10% by weight of particularized bran material, and in still another embodiment from about 15% by weight of particularized bran material, and in a further embodiment up to about 65% by weight of particularized bran material, in still a further embodiment up to about 60% by weight of particularized bran material, and yet a further embodiment up to about 55% by weight of particularized bran material.

The particle size of the subject particularized bran material is in one embodiment no coarser than at least about 90% by weight thereof being capable of passing through a 100 mesh (150 micron) screen. In another embodiment, the subject bran material is no coarser than at least about 95% by weight thereof being capable of passing through a 100-mesh (150 micron) screen. In still another embodiment, the subject bran material is no coarser than at least about 97% by weight thereof being capable of passing through a 100-mesh (150 micron) screen.

Stated another way, in an embodiment herein the particularized bran material can have a particle size of up to about 250 microns (60 mesh). In a further embodiment, the particularized bran material can have a particle size of up to about 200 microns (70-80 mesh). In still a further embodiment, the particularized bran material can have a particle size of up to about 150 microns (100 mesh).

It has now been determined that the bran material, when used in the subject adhesive system, facilitates various advantageous properties in the method for producing panel boards.

In spite of having the bran material in the adhesive system a relatively higher initial viscosity is maintained and, at the same time, a substantially stable viscosity. In one embodiment, the initial viscosity of the adhesive system including the bran material and white flour extender is at least as high, and in another embodiment from at least about 10% up to about 40% higher, and in yet another embodiment at least about 15% up to about 35% higher, and in still another embodiment at least about 20% up to about 30% higher, as a comparable adhesive material including only the white flour extender.

The adhesive system of the present technology generally comprises (a) a base adhesive resin and (b) an extender material. The base adhesive resin can comprise an aldehyde polymer resin that adheres together the lignocellulosic material. In an embodiment herein, the aldehyde resins can comprise thermosetting resins such as phenol-formaldehyde, urea-formaldehyde, resorcinol-formaldehyde, or melamine-formaldehyde. The phenolic component can include any one or more of the phenols which have heretofore been employed in the formation of phenolic resins and which are not substituted at either the two ortho-positions or at one ortho- and the para-position, such unsubstituted positions being necessary for the polymerization reaction. Any one, all, or none of the remaining carbon atoms of the phenol ring can be substituted. The nature of the substituent can vary widely, and it is only necessary that the substituent not interfere in the polymerization of the aldehyde with the phenol at the ortho- and/or para-positions. Substituted phenols employed in the formation of the phenolic resins include: alkyl-substituted phenols, aryl-substituted phenols, cyclo-alkyl-substituted phenols, alkenyl-substituted phenols, alkoxy-substituted phenols, aryloxy-substituted phenols, and halogen-substituted phenols, the foregoing substituents containing from 1 to 26 and preferably from 1 (remove this space)to 12 carbon atoms. Specific examples of suitable phenols include: phenol, 2,6-xylenol, o-cresol, m-cresol, p-cresol, 3,5-xylenol, 3-4-xylenol, 3-ethyl phenol, 3,5-diethyl phenol, p-butyl phenol, 3,5-dibutyl phenol, p-amyl phenol, p-cyclohexyl phenol, p-octyl\phenol, 3,5-dicyclohexyl phenol, p-phenyl phenol, p-crotyl phenol, 3,5-dimethoxy phenol, 3,4,5-trimethoxy phenol, p-ethoxy phenol, p-butoxy phenol, 3-methyl-4-methoxy phenol, and p-phenoxy phenol.

The aldehydes reacted with the phenol can include any of the aldehydes heretofore employed in the formation of phenolic resins such as formaldehyde, acetaldehyde, propionaldehyde, furfuraldehyde, and benzaldehyde. In general, the aldehydes employed have the formula R′CHO wherein R′ is a hydrogen or a hydrocarbon radical of 1 to 8 carbon atoms. The most preferred aldehyde is formaldehyde.

Bran material as described above has been used as an additive to white flour materials to form extenders employed in the formation of lignocellulosic products. Two examples of the utilization of improved extenders including bran materials which are used in adhesive systems and combined with lignocellulosic materials to produce lignocellulosic board products have been demonstrated below.

### EXAMPLE

After the bran was totally separated from the white flour, it was ground through a 250 hp B-Pex grinder. The ground bran was then sifted through a flourmill sifter to obtain a particularized bran material having a maximum particle size of about 100 mesh (about 150 microns). The sifted, ground bran material was blended with a base extender material of white flour by weight in a Munson Blender on load cells. The extender material was added to the adhesive resin to form an adhesive system that was used in forming lignocellulosic products such as plywood and the like.

An Extender Material (50% by weight wheat flour and 50% by weight wheat bran) was formed. To reach the target viscosity of 10,000 to 12,000 cps, Extender Material and corn cob residue filler were added to an aldehyde adhesive mix as follows:
370 lbs. water
1427 lbs. Phenol-formaldehyde Resin Liquid
100 lbs. Corn Cob Residue Filler
200 lbs. Extender Material
66 lbs. 50% Liquid Caustic
25 lbs. Soda Ash

In the first mix the Extender Material was added as a direct substitution for 100% wheat flour. The first mix achieved 17,500 cps. This is considerably higher than mixes using wheat flour per se. Resin was added to the front end of the next few mixes and the target viscosity was achieved.

Next, another mix was produced with 25% less Extender Material in the mix as follows:
370 lbs. Water
1427 lbs. Phenol-formaldehyde Resin Liquid
150 lbs. Corn Cob Residue Filler
150 lbs. Extender Material
66 lbs. 50% Liquid Caustic
25 lbs. Soda Ash

In spite of this change, the target viscosity was achieved. Pre-press properties were watched very closely and it was determined that there were no changes. Bonding of the veneer layers was also closely monitored and found to be excellent.

It is to be understood that the above-referenced arrangements are only illustrative of the application for the principles of the present invention. Numerous modifications and alternative arrangements can be devised without departing from the spirit and scope of the present disclosure. While embodiments of the present invention have been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts as set forth herein. We claim all modifications and variation coming within the spirit and scope of the following claims.

1. A method for producing a lignocellulosic board product which comprises
providing lignocellulosic material;
providing an adhesive binder system comprising (a) an adhesive binder resin and (b) an extender and/or filler material comprising particularized bran material which do not have an undesirable effect on the chemical and/or the physical properties of the adhesive binder resin to which said extender and/or filler material is added, and which does not impede the performance of the adhesive binder system during subsequent use in producing said lignocellulosic board product, wherein substantially no flour balling is present in the extender and/or filler material and in the adhesive binder system, respectively;
combining said lignocellulosic material and said adhesive binder system; and
forming the combined lignocellulosic material and adhesive binder system into said lignocellulosic board product.

2. The method of claim 1, wherein said lignocellulosic board product comprises plywood.

3. The method of claim 1, wherein said particularized bran material is in finely ground, dried form.

4. The method of claim 1, wherein said extender and/or filler material includes from about 5% up to about 65% by weight of said bran material.

5. The method of claim 1, wherein the initial viscosity of the adhesive binder system including the bran material and a white flour extender is at least as high as a comparable adhesive binder system including only the white flour extender.

6. The method of claim 1, wherein the initial viscosity of the adhesive binder system including the bran material and a white flour extender is at least about 10% higher than a comparable adhesive binder system including only the white flour extender.

7. The method of claim 1, wherein the particle size of the particularized bran material is no coarser than at least about 90% by weight thereof being capable of passing through a 100 mesh screen.

8. The method of claim 1, wherein the particularized bran material has a particle size of up to about 250 microns.

9. The method of claim 1, wherein said adhesive binder resin comprises an aldehyde polymer resin which adheres together the lignocellulosic material.

10. The method of claim 1, wherein the presence of particularized bran assists in preventing over-penetration of the adhesive system into adjoining substrates of the lignocellulosic board product.

11. A method for producing lignocellulosic board product which comprises
providing lignocellulosic material;
providing an adhesive binder system comprising (a) an adhesive binder resin, and (b) an extender and/or filler material comprising from about 5% up to about 65% by weight of particularized bran material, and from about 35% up to about 95% by weight of an white flour, wherein said extender and/or filler material does not have an undesirable effect on the chemical and/or the physical properties of the adhesive binder system to which they are added, and which does not impede the performance of the adhesive binder system during subsequent use in producing said lignocellulosic board product wherein substantially no flour balling is present in the extender and/or filler material and in the adhesive binder system, respectively;
combining said lignocellulosic material and said adhesive binder system; and
forming the combined lignocellulosic material and adhesive binder system into said lignocellulosic board product.

12. The method of claim 11, wherein said lignocellulosic board product comprises plywood.

13. The method of claim 11, wherein the initial viscosity of the adhesive system including the bran material and a white flour extender is at least as high as a comparable adhesive material including only the white flour extender.

14. The method of claim 11, wherein the initial viscosity of the adhesive system including the bran material and a white flour extender is at least about 10% higher than a comparable adhesive material including only the white flour extender.

15. The method of claim 11, wherein the particle size of the particularized bran material no coarser than at least about 90% by weight thereof being capable of passing through a 100 mesh screen.

16. The method of claim 11, wherein the particularized bran material have a particle size of up to about 250 microns.

17. The method of claim 11, wherein the presence of particularized bran material improves the prepress tack of the combined lignocellulosic material and adhesive binder system.

18. The method of claim 11, wherein said adhesive binder resin comprises an aldehyde polymer resin which adheres together the lignocellulosic material.

19. The method of claim 11, wherein the presence of particularized bran assists in preventing over-penetration of the adhesive system into adjoining substrates of the lignocellulosic product.

20. The method of claim 11, wherein said adhesive binder system is sprayable.

21. A lignocellulosic board panel which comprises
lignocellulosic material; and
an adhesive system comprising (a) a adhesive binder resin and (b) an extender and/or filler material comprising from about 5% up to about 65% by weight of particularized bran material.
